(19) United States
(12) Patent Application Publication
(10) Pub. No.: US 2019/0162885 A1
(43) Pub. Date: May 30, 2019

(54) OPTICAL BANDPASS FILTER DESIGN

(71) Applicant: QUALCOMM Incorporated, San Diego, CA (US)

(72) Inventors: James Nash, San Diego, CA (US); Kalin Atanassov, San Diego, CA (US); Hasib Siddiqui, San Diego, CA (US)

(21) Appl. No.: 15/828,038

(22) Filed: Nov. 30, 2017

(51) Int. Cl. G02B 5/20

(52) U.S. Cl. CPC G02B 5/208; G02B 5/201

(57) ABSTRACT

Various embodiments are directed to an optical filter. The optical filter may include a plurality of regions. The plurality of regions may include a first region transmissive of light within a first wavelength range and a second region transmissive of light within a second wavelength range.

### TECHNICAL FIELD

This disclosure relates to an optical bandpass filter design, and specifically to an optical bandpass filter design including regions transmissive of varying wavelength ranges.

### BACKGROUND

Optical filters can be used to attenuate or enhance an image by transmitting or reflecting (e.g., blocking) particular wavelengths of light. Various types of optical filters exist including dichroic (also referred to as interference) filters, absorptive filters, longpass filters, bandpass filters, shortpass filters, and the like. An optical filter that is designed to transmit a narrow band of wavelengths must sufficiently reject all other wavelengths. However, some optical filters (e.g., dichroic filters and the like) designed to transmit a particular range of wavelengths may be extremely angle sensitive, meaning light must strike the optical filter at an ideal angle of incidence (AOI) in order to be transmitted via the optical filter. If light strikes the optical filter at a non-ideal AOI, the apparent wavelength of the light may shift toward shorter wavelengths (outside of the range of wavelengths transmitted by the optical filter), thus being blocked by the optical filter because the optical filter is designed to only transmit the particular range of wavelengths. As such, light that should have been transmitted via the optical filter (because the original wavelength of the light was within the range of wavelengths to transmit via the optical filter prior to striking the optical filter) may actually be rejected by the optical filter due to the apparent wavelength shift of the light striking the optical filter at a non-ideal AOI.

### SUMMARY OF THE INVENTION

This disclosure describes various embodiments of an optical bandpass filter design.

Various embodiments may include an optical filter including a plurality of regions. The plurality of regions may include a first region transmissive of light within a first wavelength range and a second region transmissive of light within a second wavelength range.

In some embodiments, the first region and the second region may be concentric. In some embodiments, the optical filter may include a center point such that a center point of the first region aligns with the center point of the optical filter.

In some embodiments, the second region may surround the first region such that the first region is an inner region and the second region is an outer region.

In some embodiments, the light transmitted via the second region has a wavelength within the first wavelength range prior to the light being received at the bandpass filter.

In some embodiments, the optical filter is included within a device. In some embodiments, the device may include an optical transmitter and an optical receiver. In some embodiments, the optical transmitter may be configured to transmit a source light. In some embodiments, the optical receiver may be configured to receive a reflection of the source light. In such embodiments, the optical filter may be disposed in front of a photodetector of the optical receiver such that the received source light is received at the optical filter prior to the photodetector receiving the source light.

In some embodiments, the optical filter may be configured to transmit light received at the optical filter at an angle of incidence equal to or less than a maximum chief ray angle associated with the device.

In some embodiments, the optical filter may be an infrared or near infrared bandpass filter.

In some embodiments, the plurality of regions of the optical filter may include a third region. The third region of the optical filter may be transmissive of light within a third wavelength range. The light transmitted via the third region may have a wavelength within the first wavelength range prior to the light being received at the optical filter

In some embodiments, the first region, the second region, and the third region may be concentric.

In some embodiments, the second region may surround the first region and the third region may surround the second region such that the first region and the second region are inner regions of the third region.

Various embodiments may include a device for capturing an image. In some embodiments, the device may include an optical transmitter and an optical receiver. The optical transmitter may be configured to transmit a source light. The optical receiver may be configured to receive a reflection of the source light. The device may include an infrared or near infrared bandpass filter. The infrared or near infrared bandpass filter may be disposed in front of a photodetector of the optical receiver such that the received source light is received at the bandpass filter prior to the photodetector receiving the source light. The bandpass filter may include a plurality of regions. The plurality of regions may include a first region transmissive of light within a first wavelength range and a second region transmissive of light within a second wavelength range.

Various embodiments may include a method for capturing an image via an image capturing device. In some embodiments, the method may include transmitting a source light via an optical transmitter. The method may also include receiving light, including reflections of the source light, via an optical receiver. The optical receiver may include an infrared or near infrared bandpass filter disposed in front of a photodetector of the optical receiver such that the received source light is received at the bandpass filter prior to the photodetector receiving the source light. The bandpass filter may include a plurality of regions. The plurality of regions may include a first region transmissive of light within a first wavelength range and a second region transmissive of light within a second wavelength range.

### BRIEF DESCRIPTION OF THE DRAWINGS

FIG. 1 is an example diagram illustrating a device and a scene including a field of view of the device.

FIGS. 2A-2B are cross-sectional views of light striking an optical filter at an ideal angle of incidence.

FIGS. 2C-2D are cross-sectional views of light striking an optical filter at a non-ideal angle of incidence.

FIG. 3 is a graph of transmission spectra at angles of incidence of 0° and 20° of a conventional optical filter.

FIGS. 4A-4B are illustrations of optical bandpass filters, according to some embodiments.

FIG. 5 is an illustration of an optical bandpass filter, according to some embodiments.

FIG. 6 is an illustration of an optical bandpass filter, according to some embodiments.

FIG. 7 is an illustration of an optical bandpass filter, according to some embodiments.

FIG. 8 is a flowchart of a method for capturing an image via an image capturing device, according to some embodiments.

FIG. 9 is a component block diagram illustrating an example of a device suitable for use with some embodiments.

### DETAILED DESCRIPTION

Optical filters can be used to attenuate or enhance an image by transmitting or reflecting (e.g., blocking) particular wavelengths of light. Various types of optical filters exist including dichroic (also referred to as interference) filters, absorptive filters, longpass filters, bandpass filters, shortpass filters, and the like. An optical filter that is designed to transmit a narrow band of wavelengths must sufficiently reject all other wavelengths. However, some optical filters (e.g., dichroic filters and the like) designed to transmit a particular range of wavelengths may be extremely angle sensitive, meaning light must strike the optical filter at an ideal angle of incidence (AOI) in order to be transmitted via the optical filter. If light strikes the optical filter at a non-ideal AOI, the apparent wavelength of the light may shift toward shorter wavelengths (outside of the range of wavelengths transmitted by the optical filter), thus being blocked by the optical filter because the optical filter is designed to only transmit the particular range of wavelengths. As such, light that should have been transmitted via the optical filter (because the original wavelength of the light was within the range of wavelengths to transmit via the optical filter prior to striking the optical filter) may actually be rejected by the optical filter due to the apparent wavelength shift of the light striking the optical filter at a non-ideal AOI.

Consumer active depth mapping systems are increasingly tasked with outdoor operation for applications such as biometric security. Depth systems may transmit in a narrowband and any unwanted out of band leakage due to sunlight may decrease signal-to-noise ratios which can render outdoor operation impossible. The traditional solution is to include a narrow bandpass filter centered around the source band, which is typically small. However, oblique rays impinging on the filter may experience a downward wavelength shift. Therefore, the filter bandwidth must be enlarged to accommodate large angles of incidence.

In overview, various embodiments provide for an angle of incidence selective anisotropic optical bandpass filter design. In some embodiments, the optical bandpass filter design matches the required filter bandwidth based on the angle of incidence by depositing the optical bandpass filter in concentric rings. Each region (e.g., ring) may be matched to an increasing angle of incidence while maintain the constant narrowband of the source. Each region (e.g., ring) may reject the maximum amount of unwanted interference and there the optical bandpass filter may ultimately maximize the signal-to-noise ratio.

Various embodiments will be described in detail with reference to the accompanying drawings. Generally, the same reference numbers will be used throughout the drawings to refer to the same or similar part. References made to particular examples and implementations are for illustrative purposes only, and are not intended to limit the scope of the disclosure or the claims.

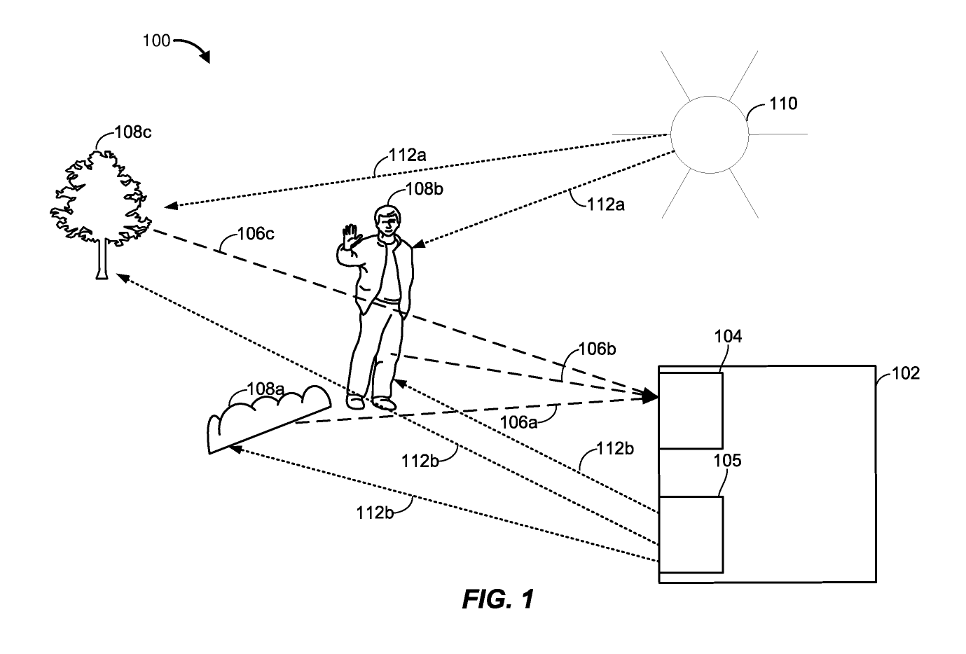

FIG. 1 is a diagram illustrating a scene, a device 102, and various objects within the scene and within a field of view of the device 102. As shown in FIG. 1, the device 102 may include an optical receiver 104 and an optical transmitter 105. Examples of device 102 may include an image capture device, such as a camera, that may be or may be part of a desktop computer, a laptop computer, a tablet, a personal digital assistant, a personal camera, a digital camera, an action camera, a mounted camera, a connected camera, a wearable device, an automobile, a drone, a wireless communication device, a phone, a television, a display device, a digital media player, a video game console, or a video streaming device. Device 102 may be capable of capturing still or moving images, regardless of format (e.g., digital, film, etc.) or type (e.g., video camera, still camera, web camera, etc.). Device 102 may include an active depth mapping system such as a time of flight system, a structured light system, or the like. Device 102 may be used to capture images (e.g., 2D images, 3D images, depth maps, etc.) for various purposes including, but not limited to, biometric security (e.g., face scan, gestures, etc.), leisure, and the like.

Examples of optical transmitter 105 may include a projector, a laser, or the like. Examples of optical receiver 104 may include one or more optical sensors (e.g., image sensors). In some examples, optical transmitter 105 may transmit a source light (e.g., IR light, NIR, light, structured light that includes a pattern or codeword, a flash, etc.) into the scene and the optical receiver 104 may receive visible light and/or the source light reflected off of objects within the scene. In some embodiments, optical transmitter 105 may transmit (e.g., emit) the source light in a narrowband of particular wavelengths and/or ranges of wavelengths of light (e.g., the source light may include a narrowband of wavelengths of light).

The field of view (“FOV”) of device 102 may include objects 108a-c, including a bush 108a, a person 108b, and a tree 108c. The scene 100 may include an external light source 110 independent from the device 102. Example external light sources 110 may include a natural light source (e.g., the sun) or an artificial light source external from device 102. Reflected light 106a-c may represent paths of light reflected off of objects 108a-c, respectively. Emitted light 112a may represent paths of light emitted from external light source 110. Emitted light 112b may represent paths of a source light transmitted from optical transmitter 105.

Optical receiver 104 may sense light (e.g., visible signals, IR signals, and/or NIR signals), for example via optics of device 102 not shown in this figure, and thus capture an image of the FOV of device 102 based on the sensed light. The light received by optical receiver 104 may include reflections of the source light transmitted via optical transmitter 105. The light received by optical receiver 104 may include light from external light source 110 and/or reflections of light from external light source 110. In other words, optical receiver 104 may absorb the emitted light from external light source 110 directly or after it reflects off of objects 108a-c within the FOV of device 102. In some embodiments, optical transmitter 105 may transmit source light 112b when device 102 is used to capture an image. In other embodiments, the optical transmitter 105 may provide constant illumination for the duration of a sensing period of optical receiver 104. In some embodiments, optical receiver 104 and optical transmitter 105 may be two independent (e.g., separate) components that are configured to operate together. Optical receiver 104 may be configured to generate an image of the FOV based on the received light.

As with optical transmitter 105, external light source 110 may function independently of device 102 (for example, as a constantly illuminated source such as the sun) or may function dependent upon device 102 (for example, as an external flash device). For example, external light source 110 may include an exterior light that constantly emits emitted light 112a within the FOV of device 102 or in a portion of the FOV of device 102.

Device 102 may be capable of determining depth of a scene or depth of an object based on light received at optical receiver 104. The example embodiment of FIG. 1 shows optical receiver 104 receiving reflected light 106a-c from objects 108a-c within the FOV of device 102. As shown, objects 108a-c may be at various depths from device 102. However, in some embodiments, objects 108a-c may be at a single depth from device 102.

In some embodiments, device 102 and/or optical receiver 104 may include an optical filter. The optical filter may be disposed (e.g., placed) in front of a photodetector of an image sensor included within optical receiver 104 such that reflections of the source light transmitted via optical transmitter 105 may be received at the optical filter prior to being received at the photodetector of the image sensor of optical receiver 104. As described above, in some embodiments where optical transmitter 105 transmits the source light in a narrowband, optical receiver 104 may be configured to receive the narrowband source light. The optical filter may be placed in front of optical receiver 104 (or anywhere between the front of optical receiver 104 and the photodetector of the image sensor included within optical receiver 104) such that the optical filter may filter out (e.g., block) wavelengths of light that are not associated with the narrowband of wavelengths of the source light. In this manner, the optical filter may allow particular wavelengths of light to pass through the optical filter and thus be received at optical receiver 104.

The optical filter may include, but is not limited to, interference filters, dichroic filters, absorptive filters, monochromatic filters, infrared filters, ultraviolet filters, longpass filters, bandpass filters, shortpass filters, and other filters. Optical bandpass filters are typically configured to selectively transmit wavelengths within a certain range while rejecting wavelengths outside of that range. Narrow bandpass filters are typically configured to transmit a narrow region of the spectrum (e.g., a narrow region of the NIR or IR spectrum when using an IR or NIR narrow bandpass filter) while rejecting light outside of the narrow region of the spectrum (e.g., rejecting visible light if the narrow bandpass filter is an IR or NIR narrow bandpass filter). An example of a narrow bandpass filter may include an infrared or near infrared bandpass filter that is configured to transmit infrared or near infrared wavelengths of light. By disposing the optical filter (e.g., a narrow bandpass filter, optical bandpass filter, or the like) in a location in front of the photodetector of the image sensor of optical receiver 104, the optical filter may filter light (e.g., reject interference light while transmitting the source light and/or reflections of the source light) prior to the light entering the photodetector region of the optical receiver 104. For example, the optical filter may transmit light within a narrow wavelength range (e.g., allow the light to pass through), while rejecting light outside of the narrow wavelength range. The light, having been filtered by the optical filter, may then enter and be detected by the photodetector of optical receiver 104. In this manner, only light within a particular wavelength range (or more than one particular wavelength range) associated with the optical filter may be detected by optical receiver 104 via the optical filter (e.g., narrow bandpass filter, optical bandpass filter, or the like), such as NIR and/or IR light.

As discussed above, in some embodiments, optical transmitter 105 may be configured to transmit a narrowband source light (e.g., infrared or near infrared light). In scenarios where device 102 may be used outdoors, such as the example scene of FIG. 1, light from the sun may result in a lower than ideal signal to noise ratio, which can render outdoor operation impractical. This sunlight (which may be referred to as interference or out of band leakage because it is not associated with and/or part of the source light which optical receiver 104 is configured to receive/capture) received at optical receiver 104 may result in noise, artifacts, oversaturation, and/or other imperfections of the resulting captured image.

The traditional solution to filter out sunlight and/or interference light (e.g., light that is not associated with the source light transmitted via optical transmitter 105 and/or light that is not associated with light intended to be captured by device 102) from being received at optical receiver 104 includes disposing (e.g., placing) a narrow bandpass filter in front of optical receiver 104 such that the sunlight and/or interference light not associated with the source light and/or light intended to be captured by device 102 may be filtered out prior to the light being received at optical receiver 104. However, the quality of the resulting image captured by device 102 depends upon the narrow bandpass filter rejecting as much of the interference light as possible and transmitting as much of the source light/intended light to be captured as possible.

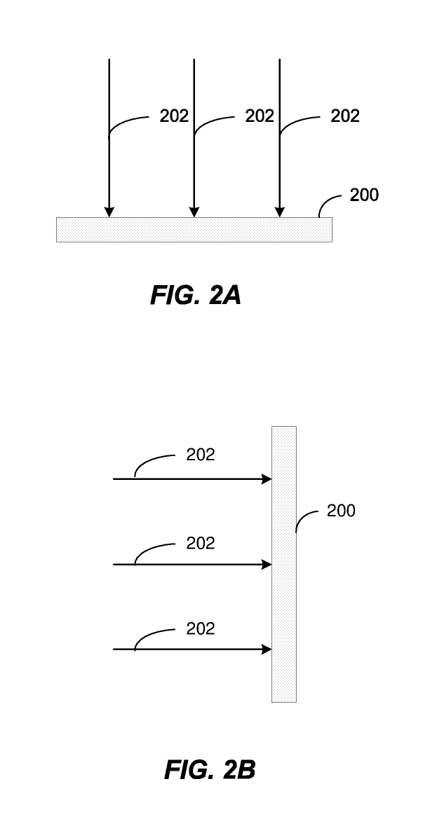

Optical bandpass filters (e.g., broadband optical filters, narrow bandpass optical filters, etc.) may be sensitive to angles of incidence of the light striking the optical filter. FIGS. 2A and 2B illustrate a cross-sectional view of an optical filter 200 with light 202 striking optical filter 200 at an angle of incidence (also referred to herein as “AOI”) of 0°. Optical filter 200 may include an optical bandpass filter. While FIGS. 2A and 2B show different orientations of optical filter 200, as can be seen, light 202 is shown to strike optical filter 200 at an AOI of what may be considered 0°. In other words, the angle at which light 202 strikes optical filter 200 may be perpendicular (e.g., 90°) or near-perpendicular to optical filter 200. This may be referred to as an ideal AOI. The ideal AOI may include a range from 0° to 3°, 0° to 5°, 0° to 7°, 0° to 10°, or the like. In other words, the ideal AOI is not strictly limited to 0°.

While light 202 striking optical filter 200 at an AOI of 0° is ideal, it is not always practical in the real world. For example, light 202 may strike optical filter 200 at an AOI greater than 0° (light 202 does not perpendicularly strike optical filter 200). Light that strikes the optical filter at a non-ideal AOI may be referred to herein as oblique light. In this scenario, the spectral properties of the optical bandpass filters may shift the wavelengths of the light to shorter wavelengths. The greater the AOI (e.g., 10°, 20°, 30°, etc.), the bluer the wavelength shift (e.g., the greater the AOI, the shorter the wavelength). Thus, the oblique light, having struck optical filter 200 at an angle that is not perpendicular to optical filter 200, may shift to a wavelength outside of the wavelength range associated with optical filter 200 and may be rejected by optical filter, even if the oblique light was originally part of the narrowband source light emitted by optical transmitter 105 of FIG. 1. Examples of oblique light 204 striking (e.g., impinging) optical filter 200 is shown in FIGS. 2C and 2D.

The wavelength shift of the light striking the optical filter depends upon the AOI at which the light strikes the optical filter. The wavelength shift for a given AOI may be determined by Equation 1:

$$λ ( θ ) = {λ}_{0} \sqrt{1 - {( \frac{sin θ}{n} )}^{2}} \qquad Equation 1$$

Referring to Equation 1, λ refers to the wavelength of the light, θ refers to the angle of incidence (AOI), λ₀ refers to the wavelength of the light at an ideal AOI (e.g., 0°, such that the light strikes/impinges the optical filter perpendicularly), and n refers to the effective index of refraction of the optical filter. The effective index n may differ for different optical filters. As discussed above, the greater the AOI, the greater the “blueshift” of the wavelength (e.g., the wavelength of the light shifts downward or shorter towards the blue color of the spectrum).

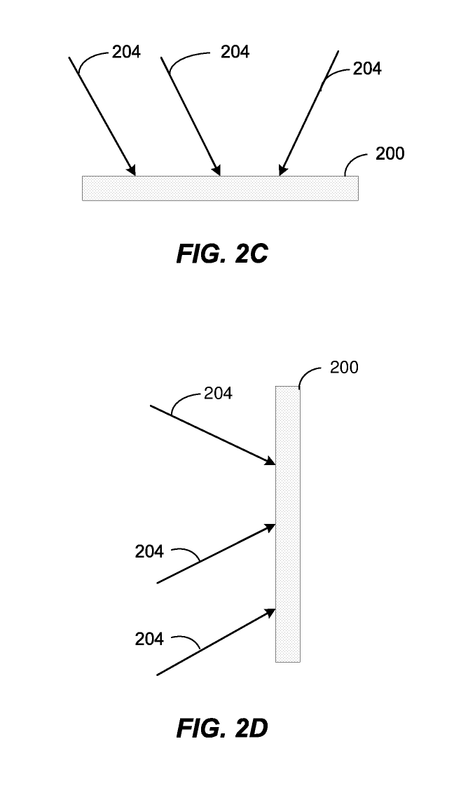

FIG. 3 is a graph of transmission spectra 302 and 304 at AOI of 0° (plot line 302) and 20° (plot line 304) for a conventional optical filter designed to transmit light at a wavelength of 825 nm over an AOI range of 0° to 20°.

For example, an optical bandpass filter may have a width of 10 nm. If the source light (e.g., light intended to be captured by the image sensor) strikes the optical bandpass filter at an AOI of 30° and shifts the wavelength of the light downward by 20 nm (e.g., for example purposes only), that source light is now out of the acceptable bandwidth of the optical filter. As such, the optical filter may reject the source light.

A solution to the problem of downward wavelength shifting when the light strikes the optical filter at a non-ideal AOI (e.g., oblique light) includes widening the passband of the optical filter to allow a wider range of wavelengths of light (e.g., widening the bandwidth of the example optical filter above from 10 nm to 30 nm). However, widening the passband of the optical filter allows more interference (e.g., ambient light) to pass through the optical filter, reducing the signal-to-noise ratio (SNR). This is a particular problem outside with sunlight causing a lot of interference. As such, a solution to maximize the signal to noise ratio (SNR) by rejecting as much interference light as possible while transmitting as much narrowband source light as possible is disclosed.

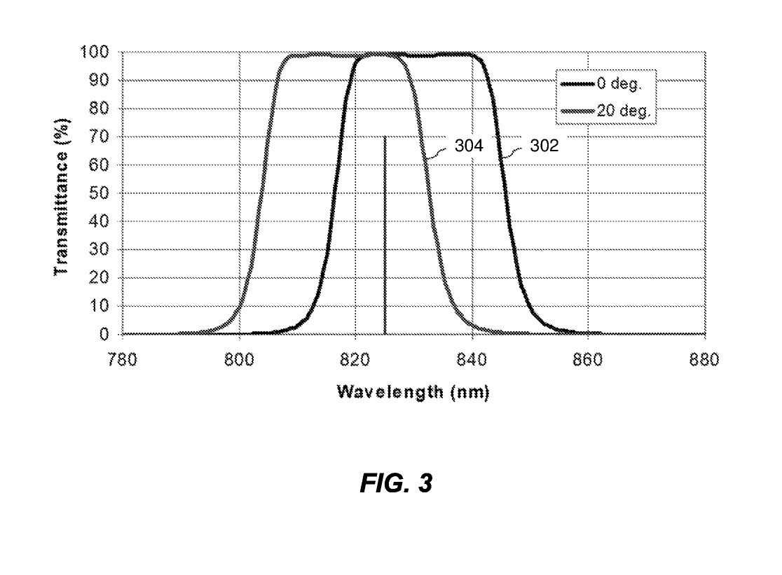

Referring to FIGS. 4A and 4B, an optical filter 400 including a plurality of regions 402 is illustrated. Optical filter 400 may include a bandpass filter, a narrow bandpass filter (e.g., an infrared or near infrared narrow bandpass filter or the like), or the like. As shown in FIGS. 4A and 4B, optical filter 400 may include a first region 402a and a second region 402b. In some embodiments, optical filter 400 may include a third region 402c and other regions up to region 402n. It should be noted that the number of regions 402 illustrated in FIGS. 4A and 4B is not meant to be a limitation of the disclosure, as optical filter 400 may include any number of regions (e.g., up to region 402n).

Each region of the plurality of regions 402n may be transmissive of light within a particular wavelength range. For example, first region 402a may be transmissive of light within a first wavelength range and second region 402b may be transmissive of light within a second wavelength range. In embodiments including a third region (e.g., third region 402c), the third region (e.g., third region 402c) may be transmissive of light within a third wavelength range. For example, first region 402a may include a narrow bandwidth (e.g., 5 nm) while outer region 402n may include wide bandwidth (e.g., 30 nm). The bandwidth of each region may increase from first region 402a to outer region 402n.

Each region of the plurality of regions 402n may be transmissive of light within a wavelength range associated with an AOI that the light (e.g., the source light) strikes optical filter 400. For example, as discussed above, when light strikes a traditional bandpass filter at an AOI greater than 0°, the wavelength may shift downward (e.g., become shorter or bluer). In instances in which the traditional optical bandpass filter is included within a device (e.g., device 102 of FIG. 1) configured to capture a particular range or ranges of light wavelengths, light intended to be captured (e.g., the source light) may be rejected by the traditional bandpass filter because the source light strikes the traditional bandpass filter at an AOI greater than 0° (that is, the source light does not perpendicularly strike the traditional optical bandpass filter) and is then perceived to be out of the acceptable transmission range of the traditional bandpass filter. In embodiments where optical transmitter 105 of FIG. 1 transmits the source light in a narrowband, optical filter 400 may be designed to transmit the source light regardless of the AOI at which the source light strikes optical filter 400 (e.g., as long as the wavelength of the light after the wavelength shift based on the AOI is within one of the wavelength ranges of plurality of regions 402 of optical filter 400).

For example, the source light (e.g., reflections of the source light) may strike first region 402a at an AOI within a first range (e.g., first region 402a may be associated with a first AOI range). The first AOI range may include 0° to 10°. The source light may strike second region 402b at an AOI within a second range (e.g., second region 402b may be associated with a second AOI range). The second AOI range may include 10° to 20°. In embodiments including third region 402c, the source light may strike third region 402c at an AOI within a third range (e.g., third region 402c may be associated with a third AOI range). The third AOI range may include 20° to 30°. These ranges are for exemplary purposes only and are not meant to be a limitation of this disclosure. For example, the first AOI range may include 0° to 5° or 0° to 15°. Similarly, the other regions of optical filter 400 may be associated with various AOI ranges.

Optical filter 400 may be designed (e.g., configured) to transmit light received at optical filter 400 at an AOI equal to or less than a maximum chief ray angle associated with the device (e.g., device 102) in which optical filter 400 is included. The chief ray angle associated with the device (or the chief ray angle associated with a camera or optical system) may define the cone angles that the light passing through the center of the lens will follow. In other words, the chief ray angle is the angle between the optical axis and the chief ray. Mobile devices are generally associated with chief ray angles ranging from 20° to 30°. As such, optical filter 400 may be customized for any device such that the outermost region 402n of optical filter 400 may be equal to or less than the chief ray angle associated with the device in which optical filter 400 is included (e.g., the outermost region 402n of optical filter 400 may transmit source light striking optical filter 400 at an AOI ranging from 20° to 30° for mobile devices with a chief ray angle ranging from 20° to 30°).

As the source light strikes optical filter 400 at increasing angles of incidence, optical filter 400 may be transmissive of the source light even after the source light strikes optical filter 400 at an AOI greater than 0°. In other words, even though the source light may shift downwards upon striking optical filter 400, prior to striking optical filter 400 at any of the plurality of regions 402, the wavelength of the source light may be the same or may be within the same wavelength range. For example, the light transmitted via second region 402b may have a wavelength within the first wavelength range prior to being received at optical filter 400. Similarly, in embodiments including more than two regions (e.g., third region 402c, up to outermost region 402n), the light transmitted via the other regions 402c . . . 402n may have a wavelength within the first wavelength range prior to being received at optical filter 400 (e.g., the first wavelength range being the wavelength of the light striking optical filter 400 at an ideal AOI).

The various wavelength ranges (e.g., the first wavelength range, the second wavelength range, the third wavelength range, etc.) may be distinct wavelength ranges such that wavelengths of the first wavelength range do not overlap with the second wavelength range. Alternatively, the various wavelength ranges may overlap. The first wavelength range may gradually taper into the second wavelength range. The second wavelength range may gradually taper into the third wavelength range. In other words, the AOI of the light striking optical filter 400 may gradually increase from first region 402a to the outer region 402n. The AOIs associated with each region of optical filter 400 may increase outward from the center of optical filter 400.

In some embodiments, and as shown in FIGS. 4A and 4B, first region 402a and second region 402b may be concentric. That is, first region 402a and second region 402b may share a common center point 404. In embodiments including more than two regions, all or some of the regions 402 may be concentric. For example, first region 402a, second region 402b, and third region 402c may be concentric. That is, first region 402a, second region 402b, and third region 402c may share common center point 404.

Common center 404 may also be a center point of optical filter 400. That is, optical filter 400 may include a center point (e.g., common center 404 of FIGS. 4A and 4B) such that the center point of optical filter 400 may align with center points of the plurality of regions 402 of optical filter 400.

As shown in FIGS. 4A and 4B, one or more of the plurality of regions 402 may surround one or more other regions of the plurality of regions 402. For example, second region 402b may surround first region 402a. As such, first region 402a may be considered an inner region of second region 402b. In embodiments with more than two regions, second region 402b may surround first region 402a and third region 402c may surround second region 402b such that first region 402a and second region 402b may be inner regions of third region 402c.

Any of the regions 402 of optical filter 400 may take any shape or form including, but not limited to, circles, ellipses, squares, rectangles, or any other shape. For example, as shown in FIG. 4A, the plurality of regions 402 may be in the shape of circles, while the plurality of regions 402 of FIG. 4B may be in the shape of ellipses. With reference to FIGS. 4A and 4B, the plurality of regions 402 may be radially symmetric, but that is not meant to be a limitation of this disclosure.

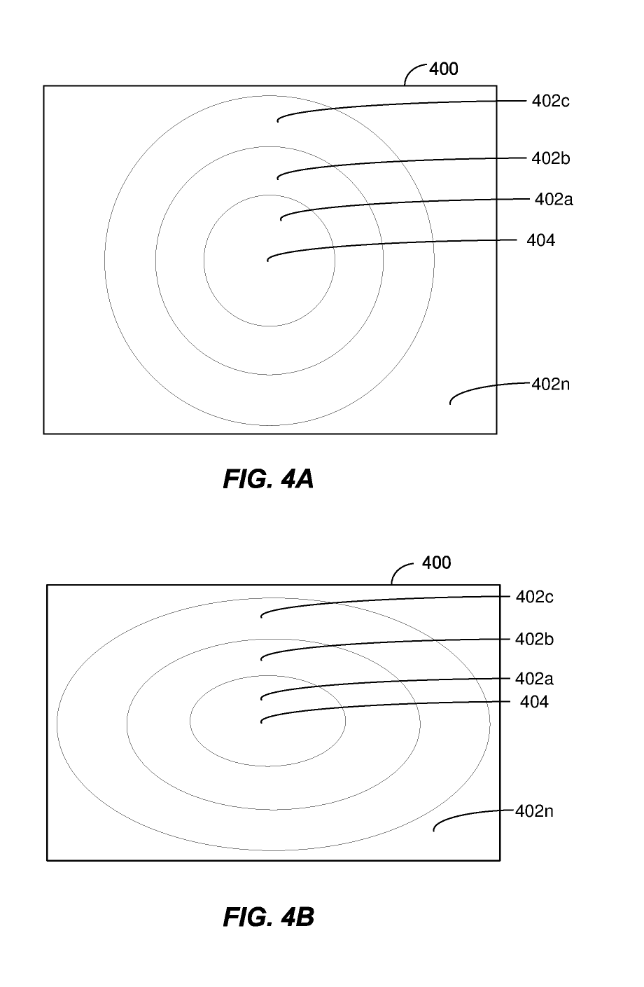

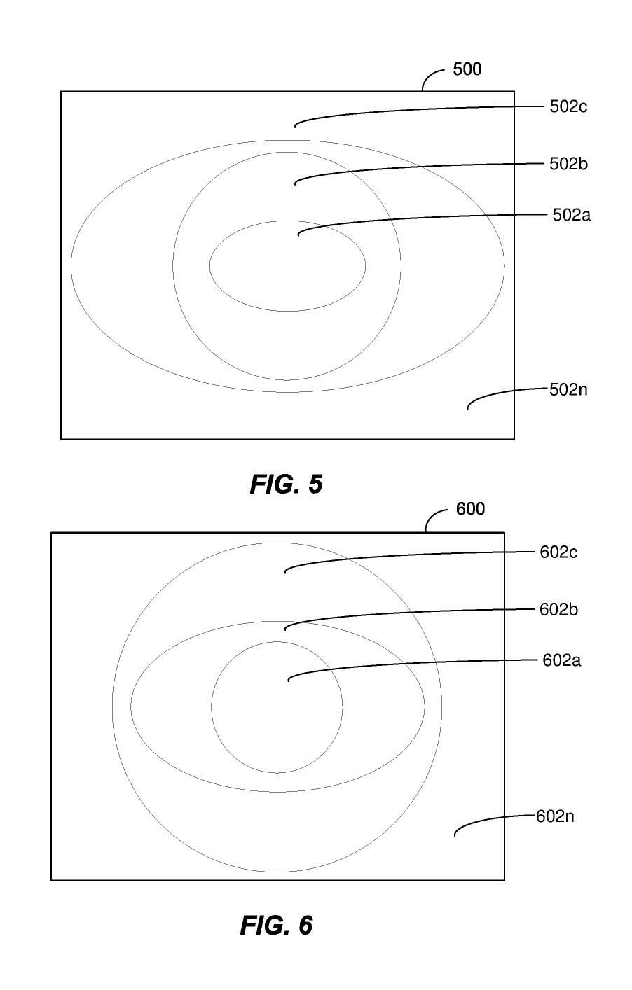

Referring to FIGS. 5 and 6, each region of the plurality of regions 502a-502n and 602a-602n, respectively, may take different shapes or forms. For example and referring to FIG. 5, first region 502a may be in the shape of an ellipse and second region 502b may be in the shape of a circle. In another example, referring to FIG. 6, first region 602a may be in the shape of a circle and second region 602b may be in the shape of an ellipse. These are for exemplary purposes only and is not meant to be a limitation of this disclosure.

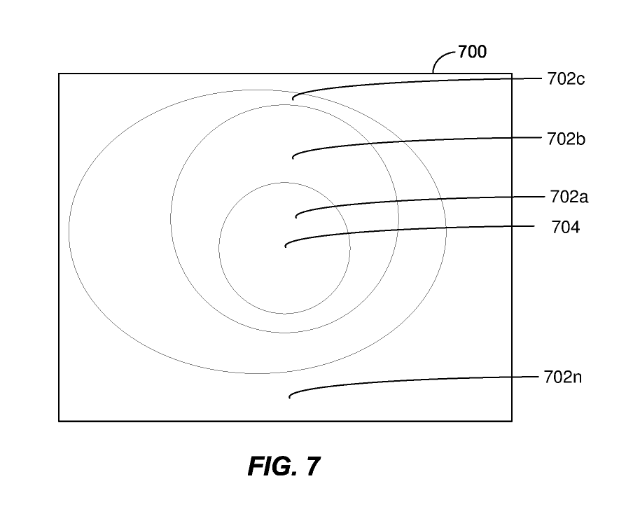

FIG. 7 illustrates optical filter 700 having a center point 704 and including a plurality of regions 702a-702n. The plurality of regions 702 of optical filter 700 may not be concentric. That is, each region of the plurality of regions 702 may not share a common center. As shown, a center point of first region 702a may share center point 704 of optical filter 700 (e.g., the center point of first region 702a may align with center point 704 of optical filter 700), the center points of second and third regions 702b and 702c may not align with center point 704 of optical filter 700.

Materials and/or layers of materials of optical filters 400-700 of FIGS. 4-7 are not particularly limited as long as the plurality of regions of the optical filter include materials (e.g., materials with a high index of refraction, thin film interference layers, dielectric and semiconductor materials, etc.) suitably designed to transmit light within wavelengths associated with the plurality of regions (e.g., associated with the wavelengths of the source light after the wavelength shift upon the source light striking the optical filter at an AOI greater than 0°). For example, a center region of the optical filter (e.g., first region 402a of FIGS. 4A and 4B) may include traditional materials and/or layers of materials to transmit a wavelength of light at or near 830 nm, 850 nm, 930 nm, or other wavelengths. As reflections of the source light emitted from optical emitter 105 of FIG. 1 are received at optical receiver, the source light may strike the optical filter at an AOI greater than 0°. When the source light strikes the optical filter at an AOI greater than 0°, the apparent wavelength shift of the source light upon striking the optical filter may be determined based on Equation 1 above. Given the wavelength shift for an AOI of, for example, 20°, the region of the optical filter associated with an AOI of 20° should include materials and/or layers of materials to transmit the wavelength of the light after the apparent wavelength shift.

As described above, the optical filter may be included within a device (e.g., device 102 of FIG. 1). The placement of the optical filter within device 102 is not particularly limited so long as the optical filter is disposed (e.g., placed) somewhere in front of or above a photodetector of the image sensor included within device 102 (e.g., the image sensor may be included within optical receiver 104), such that light may be filtered via the optical filter prior to being received at the photodetector of the image sensor. In this manner, as much of the interference light may be filtered out as possible from the intended light (e.g., the source light), such that the intended light may be received at the photodetector. While light striking the optical filter at a non-ideal AOI causes an apparent downward wavelength shift, upon the light transmitting through the various materials and/or the layers of materials of the optical filter, the wavelength of the light after passing through the optical filter may be back to its original wavelength (e.g., within the first wavelength range). The photodetector may receive and convert at least a portion of the received light (e.g., the source light, etc.) into an electrical signal. Processing resources of device 102 may convert the electrical signal into a digital signal to generate a digital image. In this manner, the optical filter may be disposed in front of or above a lens of optical receiver 104, behind or below the lens of optical receiver 104, or any other location such that the light received at optical receiver 104 is filtered prior to the light (e.g., reflections of the source light) being received at the photodetector of the image sensor of optical receiver 104.

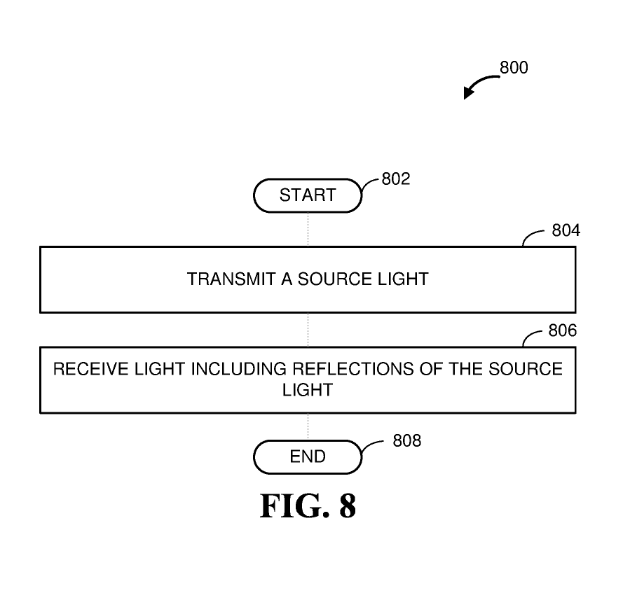

FIG. 8 is a flowchart of a method of capturing an image via an image sensor, according to some embodiments. The method 800 may begin at block 802 and proceed to block 804. At block 804, the method 800 may transmit a source light. As discussed with reference to FIG. 1, the source light may be transmitted via an optical transmitter. The method 800 may then proceed to block 806. At block 806, the method 800 may receive light including reflections of the source light. The received light may include the source light and light from external sources. As discussed with reference to FIG. 1, the received light may be received at an optical receiver. The optical receiver may include an image sensor. An optical filter, such as optical filters 400-700 of FIGS. 4-7, may be included (e.g., disposed) in front of or within the optical receiver such that the received light may be filtered prior to filtered source light entering a photodetector of the optical receiver. The method 800 may end at block 808.

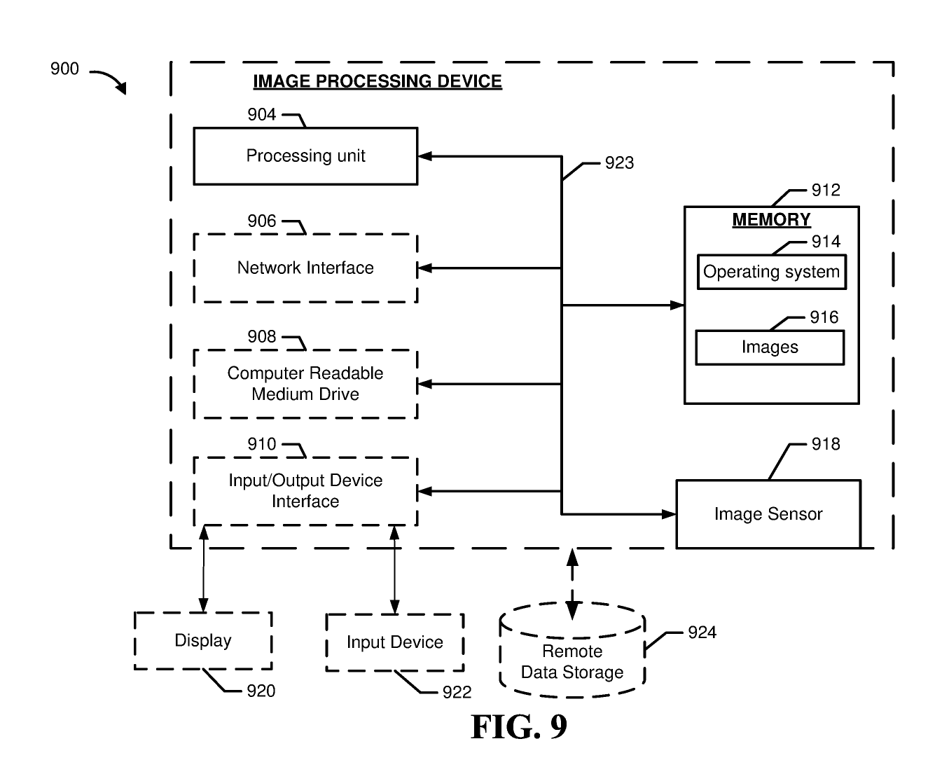

FIG. 9 depicts a general architecture of a device 900 (e.g., referred to herein as image processing device) that includes an image sensor 918, according to various embodiments. The general architecture of image processing device 900 depicted in FIG. 9 includes an arrangement of computer hardware and software components that may be used to implement aspects of the present disclosure. The image processing device 900 may include more (or fewer) elements than those shown in FIG. 9. It is not necessary, however, that all of these generally conventional elements be shown in order to provide an enabling disclosure. Although the various components are illustrated as separate components, in some examples two or more of the components may be combined to form a system on chip (SoC). The various components illustrated in FIG. 9 may be formed in one or more microprocessors, application specific integrated circuits (ASICs), field programmable gate arrays (FPGAs), digital signal processors (DSPs), or other equivalent integrated or discrete logic circuitry.

As illustrated, image processing device 900 (e.g., referred to herein as image processing device) may include a processing unit 904, an optional network interface 906, an optional computer readable medium drive 908, an input/output device interface 910, an optional display 920, and an optional input device 922, all of which may communicate with one another by way of a communication bus 923. Communication bus 923 may be any of a variety of bus structures, such as a third-generation bus (e.g., a HyperTransport bus or an InfiniBand bus), a second generation bus (e.g., an Advanced Graphics Port bus, a Peripheral Component Interconnect (PCI) Express bus, or an Advanced eXentisible Interface (AXI) bus) or another type of bus or device interconnect. It should be noted that the specific configuration of buses and communication interfaces between the different components shown in FIG. 9 is merely exemplary, and other configurations of devices and/or other image processing devices with the same or different components may be used to implement the techniques of this disclosure.

The processing unit 904 may comprise a general-purpose or a special-purpose processor that controls operation of image processing device 900. The network interface 906 may provide connectivity to one or more networks or computing systems. For example, the processing unit 904 may receive and/or send information and instructions from/to other computing systems or services via one or more networks (not shown). The processing unit 904 may also communicate to and from a memory 912 and may further provide output information for the optional display 920 via the input/output device interface 910.

The optional display 910 may be external to the image processing device 900 or, in some embodiments, may be part of the image processing device 900. The display 920 may comprise an LCD, LED, or OLED screen, and may implement touch sensitive technologies. The input/output device interface 910 may also accept input from the optional input device 922, such as a keyboard, mouse, digital pen, microphone, touch screen, gesture recognition system, voice recognition system, or another input device known in the art.

The memory 912 may include computer- or processor-executable instructions (grouped as modules or components in some embodiments) that the processing unit 904 may execute in order to perform various operations. The memory 912 may generally include random-access memory (“RAM”), read-only memory (“ROM”), and/or other persistent, auxiliary, or non-transitory computer-readable media. The memory 912 may store an operating system 914 that provides computer program instructions for use by the processing unit 904 in the general administration and operation of the image processing device 900. The memory 912 may further include computer program instructions and other information for implementing aspects of the present disclosure. In addition, the memory 912 may communicate with an optional remote data storage 924.

In some embodiments, memory 912 may store or include digital representations of images 916 obtained on the image processing device 900. In some embodiments, the images 916 stored in memory 912 may include images captured using an image sensor 918. While not shown in FIG. 9, the image processing device 900 may include optical transmitter 105 and optical receiver 104 of FIG. 1. Optical receiver 104 may include image sensor 918. The image sensor 918 may convert visible, NIR, or IR light into a digital signal, which may be stored as one or more images in memory 912. The images may be stored in one or more image file formats, such as a bitmap or raster format (e.g., JPEG, GIF, and BMP) or as vector graphic formats (e.g., scalable vector graphics or “SVG” format). In some embodiments, the images 916 may include images received over a network (not shown) via the network interface 906. In such examples, the images 916 may include image files receives from a website, from a network device, or from an optional remote data storage 924.

In some embodiments, the processing unit 904 may utilize the input/output device interface 910 to display or output an image on the display 920. For example, the processing unit 904 may cause the input/output device interface 910 to display one of the images 916 for a user of the image processing device 900.

The detailed description is directed to certain specific embodiments. However, different embodiments may be contemplated. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to, or other than one or more of the aspects set forth herein.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A device, comprising:
an optical transmitter configured to transmit a source light;
an optical receiver configured to receive a reflection of the source light; and
an infrared or near infrared bandpass filter disposed in front of a photodetector of the optical receiver such that the received source light is received at the bandpass filter prior to the photodetector receiving the source light, the bandpass filter including a plurality of regions including:
a first region transmissive of light within a first wavelength range; and
a second region transmissive of light within a second wavelength range.

2. The device of claim 1, wherein the first region and the second region are concentric.

3. The device of claim 1, wherein the first region is associated with a first range of angles of incidence of the light and the second region is associated with a second range of angles of incidence of the light.

4. The device of claim 1, wherein the bandpass filter includes a center point such that a center point of the first region aligns with the center point of the bandpass filter.

5. The device of claim 1, wherein the second region surrounds the first region such that the first region is an inner region and the second region is an outer region.

6. The device of claim 1, wherein the light transmitted via the second region has a wavelength within the first wavelength range prior to being received at the bandpass filter.

7. The device of claim 1, wherein the bandpass filter is configured to transmit light received at the bandpass filter at an angle of incidence equal to or less than a maximum chief ray angle associated with the device.

8. The device of claim 1, wherein the plurality of regions of the bandpass filter further includes:
a third region transmissive of light within a third wavelength range.

9. The device of claim 8, wherein the first region, the second region, and the third region are concentric.

10. The device of claim 8, wherein the second region surrounds the first region and the third region surrounds the second region such that the first region and the second region are inner regions of the third region.

11. The device of claim 8, wherein the light transmitted via the third region has a wavelength within the first wavelength range prior to being received at the bandpass filter.

12. An optical filter, comprising:
a plurality of regions including:
a first region transmissive of light within a first wavelength range; and
a second region transmissive of light within a second wavelength range.

13. The optical filter of claim 12, wherein the first region and the second region are concentric.

14. The optical filter of claim 12, wherein the first region is associated with a first range of angles of incidence of the light and the second region is associated with a second range of angles of incidence of the light.

15. The optical filter of claim 12, wherein the optical filter includes a center point such that a center point of the first region aligns with the center point of the optical filter.

16. The optical filter of claim 12, wherein the second region surrounds the first region such that the first region is an inner region and the second region is an outer region.

17. The optical filter of claim 12, wherein the light transmitted via the second region has a wavelength within the first wavelength range prior to being received at the bandpass filter.

18. The optical filter of claim 12, wherein the optical filter is included within a device, the device including:
an optical transmitter configured to transmit a source light; and
an optical receiver configured to receive a reflection of the source light, wherein the optical filter is disposed in front of a photodetector of the optical receiver such that the received source light is received at the optical filter prior to the photodetector receiving the source light.

19. The optical filter of claim 18, wherein the optical filter is configured to transmit light received at the optical filter at an angle of incidence equal to or less than a maximum chief ray angle associated with the device.

20. The optical filter of claim 12, wherein the optical filter is an infrared or near infrared bandpass filter.

21. The optical filter of claim 12, wherein the plurality of regions of the optical filter further includes:
a third region transmissive of light within a third wavelength range.

22. The optical filter of claim 21, wherein the first region, the second region, and the third region are concentric.

23. The optical filter of claim 21, wherein the second region surrounds the first region and the third region surrounds the second region such that the first region and the second region are inner regions of the third region.

24. The optical filter of claim 21, wherein the light transmitted via the third region has a wavelength within the first wavelength range prior to being received at the optical filter.

25. A method, comprising:
transmitting a source light via an optical transmitter; and
receiving a reflection of the source light via an optical receiver, the optical receiver including an infrared or near infrared bandpass filter disposed in front of a photodetector of the optical receiver such that the received source light is received at the bandpass filter prior to the photodetector receiving the source light, the bandpass filter including a plurality of regions including:
a first region transmissive of light within a first wavelength range; and
a second region transmissive of light within a second wavelength range.

26. The method of claim 25, wherein the first region and the second region are concentric.

27. The method of claim 25, wherein the first region is associated with a first range of angles of incidence of the light and the second region is associated with a second range of angles of incidence of the light.

28. The method of claim 25, wherein the bandpass filter includes a center point such that a center point of the first region aligns with the center point of the bandpass filter.

29. The method of claim 25, wherein the second region surrounds the first region such that the first region is an inner region and the second region is an outer region.

30. The method of claim 25, wherein the light transmitted via the second region has a wavelength within the first wavelength range prior to being received at the bandpass filter.

31. The method of claim 30, wherein the bandpass filter is configured to transmit light received at the bandpass filter at an angle of incidence equal to or less than a maximum chief ray angle associated with the device.

32. The method of claim 25, wherein the plurality of regions of the bandpass filter further includes:
a third region transmissive of light within a third wavelength range.

33. The method of claim 32, wherein the first region, the second region, and the third region are concentric.

34. The method of claim 32, wherein the second region surrounds the first region and the third region surrounds the second region such that the first region and the second region are inner regions of the third region.

35. The method of claim 32, wherein the light transmitted via the third region has a wavelength within the first wavelength range prior to being received at the bandpass filter.
